(19) United States
(12) Patent Application Publication
(10) Pub. No.: US 2005/0054289 A1
(43) Pub. Date: Mar. 10, 2005

(54) Communications, command, and control system with plug-and-play connectivity

(75) Inventors: Joe A. Salazar, Lompoc, CA (US); Luis Molero-Castro, Madrid (ES); Robert L. Meyers, Lompoc, CA (US)

Correspondence Address: Thomas J. Brindisi, Esq., Suite B, 20 28th Place, Venice, CA, 90291, US

(73) Assignee: Innovative Intelcom Industries

(21) Appl. No.: 10/656,633

(22) Filed: Sep. 5, 2003

(51) Int. Cl. H04B 7/24

(52) U.S. Cl. 455/39; 455/41.2

(57) ABSTRACT

A modular communications, command, and control system with plug-and-play connectivity, utilizing configurable independent base stations and portable handsets that preferably have similar components and functionality so as to be interoperable. The system utilizes an open system interconnection architecture preferably having fully integrated layers permitting inter-operability with adaptive applications and inter/intra-linking with external appliances and/or apparatuses. Optionally, the system may be utilized to perform extended information handling/processing, networking, personal assistance, industrial, commercial, medical, military, and/or security functions.

### FIELD OF THE INVENTION

The present invention relates generally to adaptive communications, remote control, sensing, information processing, and security, and more particularly, to a modular communications, command, and control system with plug-and-play connectivity, comprising one or more handsets and/or base stations that can transmit and receive communication signals and/or command signals and/or control signals.

### BACKGROUND OF THE INVENTION

It has long been known to use radio frequency (RF) and/or infrared (IR) signals to effect telephonic transmission and/or remote control of devices such as home appliances. Assignee's U.S. Pat. No. 5,802,467 issued to Salazar et al., the disclosure of which is incorporated by reference as if set forth in full herein, further taught an integrated communications, command and control device that provides, two-way, RF and/or IR and/or wired/wireless links to all types of apparatus and/or appliances for home, business, medical, or industrial use. The device taught in the Salazar patent does not need a converter with a modem or a standalone base station as an interface, and can recreate an external device's command code set from a set of parameters for the external device so as to reduce the memory space required to store command code sets. The Salazar patent, however, does not provide a universal open system interconnection that permits plug-and-play adaptability or connectivity with other devices.

Separately, in the field of computers, it is known to use open system interfaces for networking computers and related devices, and plug-and-play connectivity for computer application and peripheral installation. However, no such known devices effectively integrate remote command and control of other devices with an open system interface or plug-and-play connectivity, with or without the concurrent linking of communication signals (i.e., video, audio, text, and/or other data such as information from sensing means).

Open system interfaces and plug-and-play connectivity have also been employed in limited form in mobile telephones and Personal Digital Assistants (PDAs). Known mobile telephones, and PDAs, however, lack IR signaling functionality and wired connectivity to many devices that require the use of telephone lines, power lines, and other wired point-to-point links, and do not have plug-and-play connectivity and/or adaptability that is selectable and/or programmable. Smartphones and PDAs generally provide for remote control and IR signaling functionality, but they lack both plug-and-play functionality, as well as the adaptability required to implement security systems.

Also, none of the known prior art devices provides the possibility of security functionality such as plug-and-play capability to adapt application-specific microprocessors and/or external modules (e.g., memory) for security applications.

### SUMMARY OF THE INVENTION

In accordance with the present invention, a modular adaptive communications, command, and control system with plug-and-play connectivity is provided. The system utilizes configurable independent base stations and portable handsets, which preferably have similar components and functionality so as to be interoperable. Further, the system utilizes an open system interconnection architecture preferably having fully integrated layers permitting inter-operability with adaptive applications and inter/intra-linking with external appliances and/or apparatuses. In a separate aspect of the invention, the system of the present invention may be used with and/or include components adapted to performing extended, but not limited to, information handling/processing/networking, industrial, commercial, medical, military, and/or security functions.

### BRIEF DESCRIPTION OF THE DRAWINGS

FIG. 1 is an overview of an embodiment of a modular communications, command, and control system with plug-and-play connectivity in accordance with the present invention, along with a variety of devices that can be interfaced by the system.

FIG. 2 is a block diagram depicting the general, independent, modular and synergistic hardware architectures of a handset and a base station of a system in accordance with the present invention.

FIG. 3 is a block diagram depicting the main functional components of a handset and a base station of a system in accordance with the present invention.

FIG. 4 is a block and pictorial diagram depicting the functional architectural layering of a system in accordance with the present invention.

### DETAILED DESCRIPTION OF PREFERRED EMBODIMENTS OF THE INVENTION

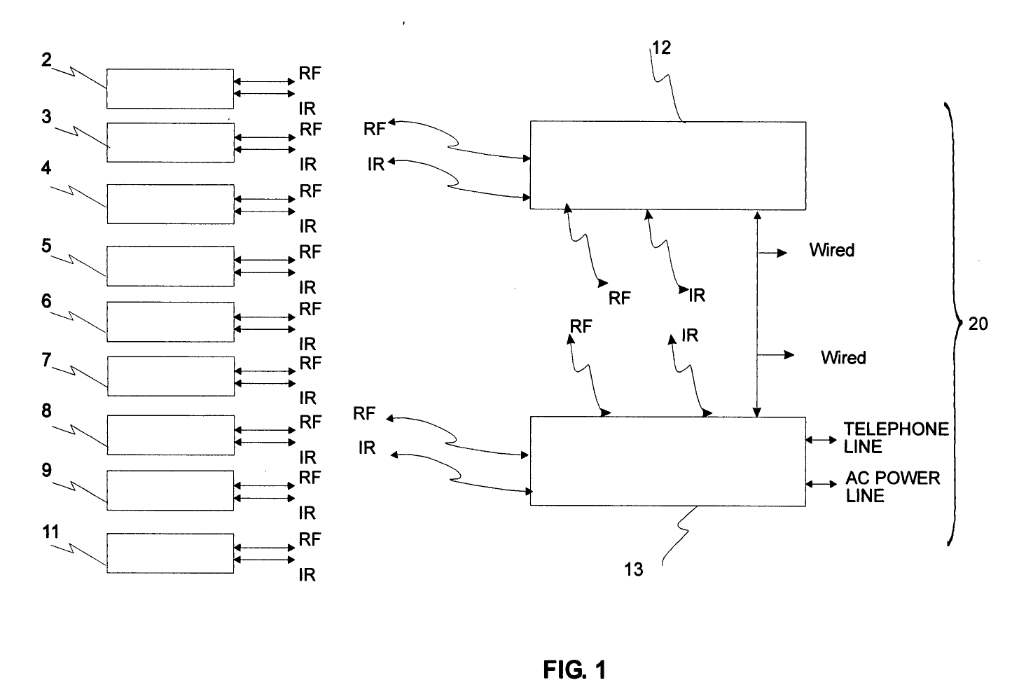

Referring to FIG. 1, a preferred embodiment of the present invention provides for two-way communication of digital and/or analog signals with a variety of devices such as intercom/pager 2, alarm 3, AC/DC actuator 4, TV/Display 5, VCR/DVD 6, cable/satellite 7, sound/voice/video 8, onboard and/or remote sensor 9, personal computer/network 10 and other device/apparatus 11 to be universally controlled by one or more handsets 12 and one or more base stations 13, utilizing plug-to-plug connectivity and via RF and/or IR and/or wireless/wired connection. Thus, the system may preferably include sensing and display means and can preferably operate in a plurality of states or modes such as sound, voice, video, alerts, text, and data, to perform telephone communications, messaging, information management, remote command, and control of appliances and/or apparatus/systems, remote monitoring and display, intercom and paging operations, and other operations.

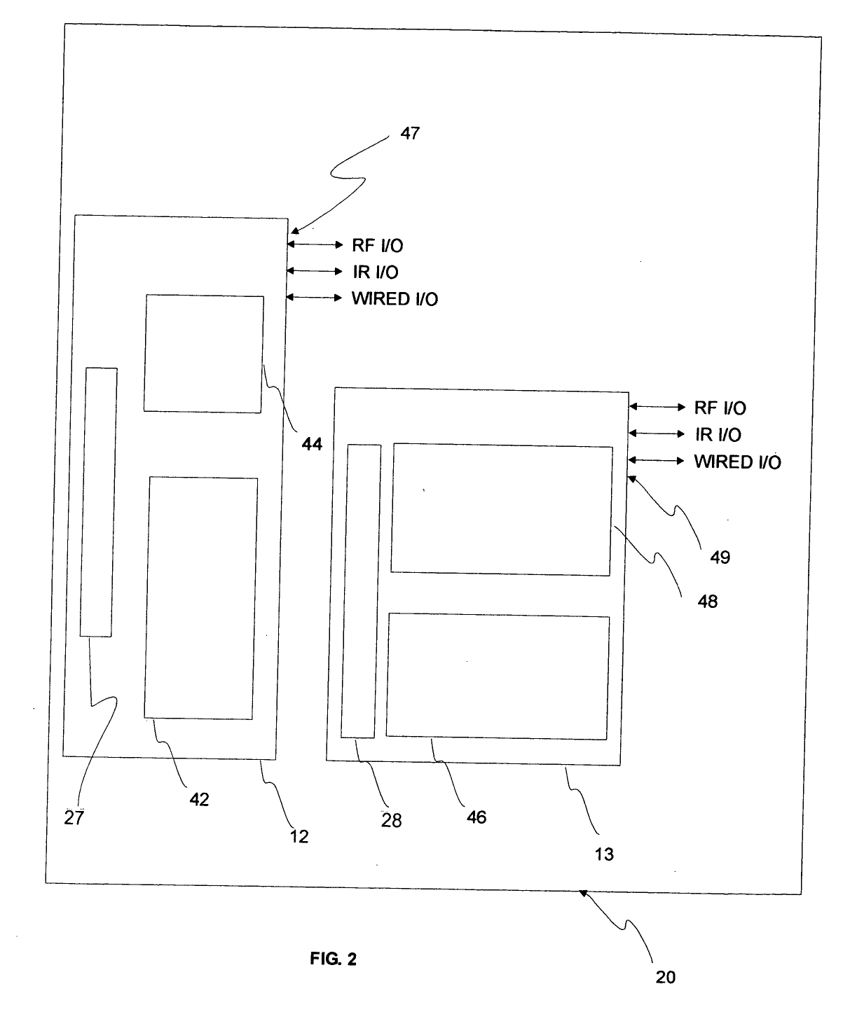

Referring now also to FIG. 2, the handset 12 and base station 13 of such an embodiment preferably include command and control keypads 42 and 46, displays 44 and 48, and plug-and-play module connectors 27 and 28. The base station 13 is preferably powered by an AC line and/or a DC backup rechargeable battery, while the handset 12 is preferably powered by a rechargeable DC battery. The handset 12 and base station 13 preferably can communicate with a plurality of handsets and base stations through input/ouput ports 47 and 49, and preferably can concurrently communicate with the same external devices. The handsets and/or base stations preferably have a generalized duplex signal transmission, reception, processing and display architectures that can interlace sound, including voice, video, text, command and control signals and sensor data with manual and/or automatic signaling to external sources, and can transmit and receive these signals over a broad frequency range and/or concurrently via plug-to-plug wired modules and linked to any number of appliances and/or apparatus capable of receiving, transmitting or linking compatible signals. Signal processing and control is preferably completely under microprocessor control. The handset 12 and base station 13 preferably can function independently of each other for the performance of the same and/or unique functions, and/or in conjunction with each other (as designated by reference number 20), in which case part or all of their functions may be performed in an integrated way between the handset and the base station to provide unique redundancy, reliability, and portability. It will be appreciated that the handset and/or base can be configured in a number of embodiments to provide custom and/or modular communications, command, and control with plug-and-play connectivity.

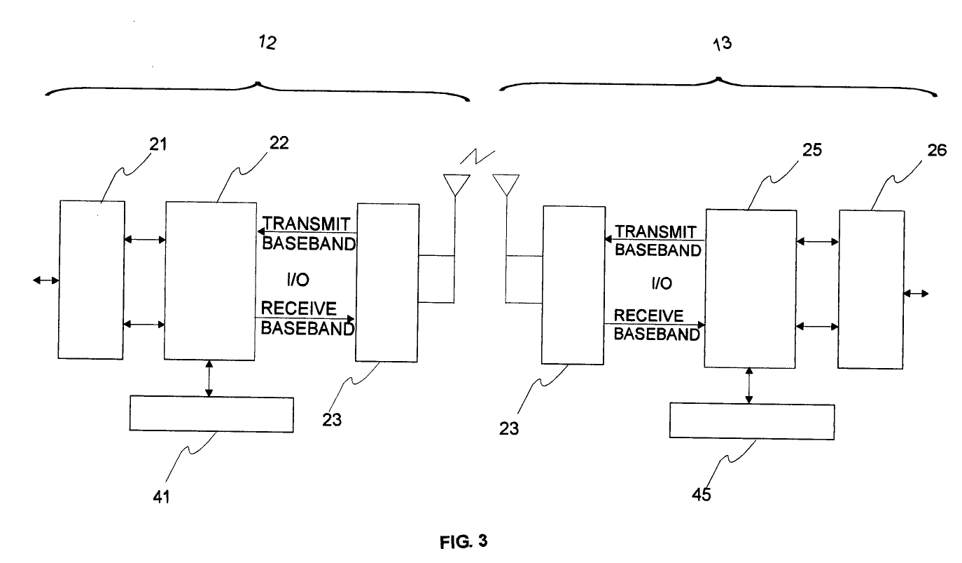

Referring now to FIG. 3, the handset 12 and base station 13 (shown, for purposes of illustration, communicating with each other) respectively include interface modules 21 and 26, master application/interface controller modules 22 and 25, radio modules 23, and, optionally, plug-and-play modules 41 and 45 that may be connected. The interface module 21 may include keypads, touch sensitive screens, switches, microphones, connectors, sound generators, light emitting devices, input and/or output controllers which permit access to the system and/or which condition and/or which provide the input/output signals. Well known prior art is readily available for the construction of a hardware/software interface for input/output operation and for two-way communication between the system and onboard and/or external devices with digital and/or analog signals for performing intercom/paging, alarm, actuating devices over AC/DC lines, controlling appliances such as television sets, display devices, VCRs and DVDs, cable/satellite reception/transmission transceivers, sound/voice/video devices, onboard and/or remote sensors, imaging and related display devices, data/text acquisition and processing, message management, information processing, and interfacing with other devices such as computers or computer networks or personal digital assistants. The master application/interface controller module 22 in the handset may be comprised of a programmable single solution IC or in combination with an ASIC with external programmable microcontrollers/memory ICs for coding and/or decoding to provide all of the communication control and key protocol functions. Similar functionality and architectures are implemented in the master application/interface controller module 25 and interface 26 of the base station 13, except that the interface 26 of the base station 13 may provide additional wired functions for interfacing to such transmission media as telephone lines, broadband and/or narrow band cables/fiber optics lines, alternating current power lines and other wired lines. The plug-and-play modules 41 and 45 may be comprised of application-specific devices such as message processors, sensors, audio processors, video processors, command and/or control devices, data processors, and/or other devices. The radio modules 23 may be comprised of a transceiver with programmable channels including a radiating/receiving antenna, and provide one-way and/or two-way RF links to each other and/or other external devices capable of receiving compatible signals.

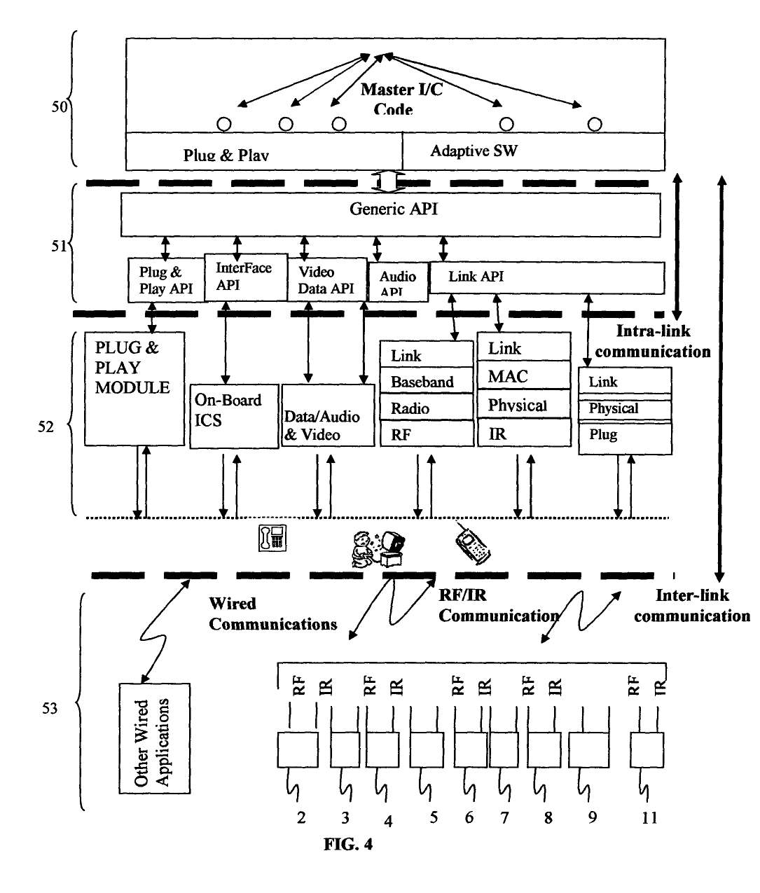

FIG. 4 depicts a preferred layered platform from which the present embodiment of the invention can be constructed using an open system interconnection architecture to interlace and/or inter/intra-link a plurality of communication links with plug-and-play applications. An external apparatus layer 53 is comprised of devices/apparatus or appliances that perform a multitude of functions and have built-in hardware/firmware or programmable functionality for communicating with other apparatus, such as the system of the present invention. The functionality is specified by a set of protocols and/or codes and/or application hardware/software, and a hardware interface layer 52 provides the input/output means for linking the internal operation of the system with the external devices. The hardware interface layer 52 preferably provides for input and output with sound, voice, RF and/or IR and/or wired means for visual display, sound, and/or alerting means. The hardware interface layer 52 also includes a plug-and-play connection in order to easily detect any I/O modules added to and/or removed from the handset 12 and/or base station 13. An application programming interface (API) layer 51 provides the master application layer 50 with a set of high-level functions and events used to make transparent the complexities of the different low level communications protocols with the different hardware I/O modules (including plug-and-play modules). The API layer 51 preferably consists of a set of generic APIs and a set of module-specific APIs, both of which are preferably easily updated whenever a new module is plugged into the device. Specific functions are also preferably provided to detect what I/O modules are connected to a certain device, as well as functions to find out the capabilities of the different modules. The master application layer 50 provides system control, preferably including capabilities for signal processing and generation, allowing the end user to interact with the handsets, bases, and other external appliances and/or apparatuses. Additional functions of this layer may preferably include extended memory, message processing, command and control, video processing, sound and/or voice processing, data processing, power management and display management. This layer further provides for full plug-and-play functionality, both at an inter-link level (between different devices) as well as at an intra-link level (between different modules within a given device), and preferably provides for full software adaptability, enabling any device to have its software remotely updated at any time, over a wired and/or wireless link.

A “generic” and technology-independent communications and control protocol may be used in order to inter/intra-link different devices within a system of the present invention. An example of a general message in this communications and control protocol, based on the IEEE 802.11b standard, could be a packet comprising a PREAMBLE, HEADER, MAC DATA, and CRC field (preferably in that order), where the MAC DATA field could in turn consist of FRAME CNTRL, ADDRESS 1, ADDRESS 2, ADDRESS 3, SEQUENCE CONTROL, DATA, and CRC fields, in which the FRAME CNTRL field could consist of PROTOCOL VERSION, TYPE, SUBTYPE, and CONTROL BITS, wherein the meaning of the most significant fields is as follows:
PREAMBLE generally a sequence of alternating zeros and ones that is used by the circuitry to select the appropriate antenna (if diversity is used), and to reach steady-state frequency offset correction and synchronization with the received packet timing. The PREAMBLE ends with a Start Frame Delimiter, which is used to define frame timing.
HEADER contains logical information used by the physical layer to decode the frame.
FRAME CONTROL contains information such as the protocol version, type and subtype of the frame, if there are more fragments belonging to the same frame following the current fragment, if this fragment is a retransmission of a previously transmitted fragment, the Power Management mode that the device will be in after the transmission of this frame, if the frame body is encrypted according to the WEP algorithm, etc.
ADDRESS 1 is the Recipient Address.
ADDRESS 2 is the Transmitter Address.
ADDRESS 3 is in most cases the remaining, missing address (used, for example, when a certain device is used to relay a certain message to a third device).
SEQUENCE CONTROL is used to represent the order of different fragments belonging to the same frame, and to recognize packet duplications. It consists of two subfields, Fragment Number and Sequence Number, which define the frame and the number of the fragment in the frame.
CRC is preferably a 32-bit cyclic redundancy check.
   In order to fully specify this generic inter-link communications and control protocol, the main COMMAND and DATA fields in the general message, provided to the master application layer by the API layer, are listed below, based on a standard such as the IEEE 802.11b specifications:
An Active_Mode command may be used to place the remote device into the active mode.
An Exit_Active_Mode command may be used to end the active mode for a remote device which is currently in active mode.
A Sleep_Mode command may be used to place the remote device into the sleep mode.
An Exit_Sleep_Mode command is used to end the sleep mode for a remote device which is currently in sleep mode.
An Inquiry command will allow a certain device to have an updated list of all active devices within range.
An Inquiry_Reply command will be sent by all active devices when an Inquiry command is received.
A Periodic_Inquiry command will allow a certain device to have an updated list of all active devices within range, by setting remote devices to perform an automatic Inquiry Reply based on a specified period range.
A Periodic_Inquiry_Reply command will be sent by all active devices when a Periodic Inquiry command is received.
An Exit_Periodic_Inquiry command will cause the device to stop the current Periodic Inquiry if the device is in Periodic Inquiry Mode, and no more Periodic Inquiry Reply messages will be accepted.
A Read_Active_Station_List command will request the list of active devices of a certain remote device.
A Write_Active_Station_List command will modify the list of active devices of a certain remote device.
A QoS_Setup command may be used to specify Quality of Service parameters for a connection handle.
A Role_Discovery command may be used for a device to determine which role the device is performing for a particular connection.
A Switch_Role command may be used for a device switch the current role the device is performing for a particular connection with the specified device.
A Create_Connection command will cause the link manager to create a connection to the device with the address specified by the command parameters.
A Disconnect command may be used to terminate an existing connection.
An Accept_Connection_Request command may be used to accept a new incoming connection request.
A Reject_Connection_Request command may be used to decline a new incoming connection request.
A Link_Key_Request command may be used to ask a certain remote device for the Link Key stored on the Host of a remote device specified by the address parameter.
A Link_Key_Request_Reply command may be used to reply to a Link Key Request command, and specifies the Link Key stored on the Host to be used as the link key for the connection with the other device specified by the address parameter.
A Link_Key_Request_Negative_Reply command may be used to reply to a Link Key Request command if the Host does not have a stored Link Key for the connection with the other device specified by the address parameter.
A Change_Connection_Link_Key command may be used to force both devices of a connection associated to the connection handle, to generate a new link key.
A Master_Link_Key command may be used to force both devices of a connection associated to the connection handle to use the temporary link key of the Master device or the regular link keys.
A PIN_Code_Request command may be used to ask a certain remote device for the PIN Code stored on the Host of a remote device specified by the address parameter.
A PIN_Code_Request_Reply command may be used to reply to a PIN Code Request command and specifies the PIN code to use for a connection.
A PIN_Code_Request_Negative_Reply command may be used to reply to a PIN Code Request command when the Host cannot specify a PIN code to use for a connection.
An Authentication_Requested command may be used to establish authentication between the two devices associated with the specified Connection Handle.
A Set_Connection_Encryption command may be used to enable and disable the link level encryption.
A Read_Remote_Name command may be used to obtain the user-friendly name of another device.
A Write_Remote_Name command may be used to modify the user-friendly name of another device.
A Read_Remote_Supported_Features command requests a list of the supported features of a remote device.
A Read_Remote_Status command requests the current status of a remote device. In case the remote device has sensing capabilities, one of the parameters returned will include the measured value.
A Write_Remote_Status command may be used to modify the current status of a remote device. Potential actions that can be sent with this command are:
   Turn a remote device on and off
   Update measured data in a remote sensor
   Mute
   Play
   Last (recall)
   Channel Up/Down
   Stop
   Volume Up/Down
   Pause
   Telephone Flash function
   Record
   Telephone Redial function
   Rewind
   Telephone Memory Dial function
   Fast Forward
   Telephone Numeric Key function (0-9, *, #)
   Enter
A Read_Remote_Display command requests the contents of the display in a remote device.
A Write_Remote_Display command will modify the contents of the display in a remote device.
A Read_Clock_Offset command allows the Host to read the clock offset of remote devices.
A Write_New_IR_Codes command will allow one or more remote devices to add a new IR code to its IR database.
An Activate_Ringer command sets the remote unit to ring the specified amount of time.
A Change_Channel command may be used to change both the RF and/or the IR communications channel.
   Of course, the list is not exhaustive as other commands associated with other devices that may be added to a system are not mentioned.

Open architecture software within a plug-and-play module's microprocessor programmed for universal remote control functions can preferably be used to create a generalized command and control protocol that makes it possible to interact via the master application/interface controller module, radio module, and interface module in a wireless and/or wired mode, with any number of external devices that have compatible transceivers with wireless communications, command, and control capability. The software also provides all the internal controls to enable necessary protocols for specified RF and IR communication links, which protocols create control signals that allow the system to be used as a remote controller for entertainment appliances or alarm systems or energy control systems or for personal security operations, etc. The plug-and-play module provides all the timing via an internal or external clock, and database updates and application programs can be downloaded into the module via wired, RF and/or IR communication links, and/or the command/control keypad. The operation of the plug-and-play module in conjunction with creating the control signals to remotely communicate with external appliances and/or apparatus is next explained in detail. (Although the following preferred embodiment description is directed to the handset 12, the same details may also be applied to the base station 13).

A “generic” and technology-independent communications and control protocol is preferably used in order to intra-link different modules within a given device. In order to facilitate this, the following is a list of some functions that may be provided to the master application layer by the API layer 51:
An Active_Mode( ) command may be used to place the local device, or any local module (including plug-and-play modules), into the active mode.
An Exit_Active_Mode( ) command may be used to end the active mode for local device, or any local module (including plug-and-play modules), which is currently in active mode.
A Sleep_Mode( ) command may be used to place the local device, or any local module (including plug-and-play modules), into the sleep mode.
An Exit_Sleep_Mode( ) command may be used to end the sleep mode for a local device, or any local module (including plug-and-play modules), which is currently in sleep mode.
An Inquiry command will allow a certain device to have an updated list of all local modules connected to its hardware interface layer (including plug-and-play modules).
A Periodic_Inquiry( ) command will allow a certain device to have an updated list of all local modules connected to its hardware interface layer (including plug-and-play modules), by setting the master application layer to perform automatic Inquiry commands based on a specified period range.
An Exit_Periodic_Inquiry( ) command will cause the device to stop the current Periodic Inquiry if the device is in Periodic Inquiry Mode.
A Set_Event_Mask( ) command may be used to control which events are generated by each local module (including plug-and-play modules) to the Host.
A Reset( ) command will reset a specified local module (including plug-and-play modules).
A Flush( ) command may be used to discard all data that is currently pending for transmission in a specified local module (including plug-and-play modules).
A Read_PIN_Type( ) command may be used for the Host to read the value that is specified to indicate whether a specified local module (including plug-and-play modules) supports variable PIN or only fixed PINs.
A Write_PIN_Type( ) command may be used for the Host to specify whether a specified local module (including plug-and-play modules) supports variable PIN or only fixed PINs.
A Read_Stored_Link_Key( ) command provides the ability to read one or more link keys stored in a specified local module (including plug-and-play modules).
A Write_Stored_Link_Key( ) command provides the ability to write one or more link keys to be stored in a specified local module (including plug-and-play modules).
A Delete_Stored_Link_Key( ) command provides the ability to remove one or more of the link keys stored in a specified local module (including plug-and-play modules).
A Change_Local_Name( ) command provides the ability to modify the user-friendly name for the device.
A Read_Local_Name( ) command provides the ability to read the stored user-friendly name for the device.
A Read_Scan_Enable( ) command will read the value for the Scan_Enable configuration parameter, which controls whether or not the device will periodically scan for page attempts and/or inquiry requests from other devices.
A Write_Scan_Enable( ) command will write the value for the Scan_Enable configuration parameter.
A Read_Authentication_Enable( ) command will read the value for the Authentication_Enable parameter, which controls whether the device will require authentication for each connection with other devices.
A Write_Authentication_Enable( ) command will write the value for the Authentication_Enable parameter.
A Read_Encryption_Mode( ) command will read the value for the Encryption_Mode parameter, which controls whether the device will require encryption for each connection with other devices.
A Write_Encryption_Mode( ) command will write the value for the Encryption_Mode parameter.
A Read_Class_of_Device( ) command will read the value for the Class_of_Device parameter, which may be used to indicate its capabilities to other devices.
A Write_Class_of_Device( ) command will write the value for the Class_of_Device parameter.
A Read_Voice_Setting( ) command will read the values for the Voice_Setting parameter, which controls all the various settings for the voice connections.
A Write_Voice Setting( ) command will write the values for the Voice Setting parameter.
A Read_Active_Mode_Activity( ) command will read the value for the Active_Mode_Activity parameter. This value may be used to determine what activity the device should do when it is in active mode.
A Write_Active_Mode_Activity( ) command will write the value for the Active_Mode_Activity parameter.
A Read_Page_Scan_Period_Mode( ) command may be used to read the mandatory Page_Scan_Period_Mode of the local device.
A Write_Page_Scan_Period_Mode( ) command may be used to write the mandatory Page_Scan_Period_Mode of the local device.
A Read Page_Scan_Mode( ) command may be used to read the default Page_Scan_Mode of the local device.
A Write_Page_Scan_Mode( ) command may be used to write the default Page_Scan_Mode of the local device.

### Informational Functions

A Read_Local Supported_Features( ) command requests a list of the supported features for a specified local module (including plug-and-play modules).
A Read_Buffer Size( ) command returns the size of the buffers of a specified local module (including plug-and-play modules). These buffers are used to buffer data that is to be transmitted.
A Read_Country_Code( ) command will read the value for the Country Code status parameter. The Country Code defines which range of frequency band of the ISM 2.4 GHz band will be used by the device.
A Read_Local_Address( ) command will read the value for the local address parameter.

### Events

An Inquiry Complete event indicates that the Inquiry is finished.
An Inquiry Result event indicates that one or multiple local modules (including plug-and-play modules) have responded so far during the current Inquiry process.
A Plug-and-play event indicates that a local module (typically a plug-and-play module) has been connected to or disconnected from the device.
An Encryption Change event may be used to indicate that the change in the encryption has been completed for the Connection Handle specified by the Connection_Handle event parameter.
A Change Connection Link Key Complete event may be used to indicate that the change in the Link Key for the Connection Handle specified by the Connection_Handle event parameter had been completed.
A Master Link Key Complete event may be used to indicate that the change in the temporary Link Key or in the semi-permanent link keys on the master side has been completed.
A Read Local Supported Features Complete event may be used to indicate the completion of the process of the Link Manager obtaining the supported features of the specified local module (including plug-and-play modules).
A Command Complete event may be used by the specified local module (including plug-and-play modules) to pass the return status of a command and the other event parameters for each command.
A Command Status event may be used to indicate that the command described by the Command_Opcode parameter has been received and the specified local module (including plug-and-play modules) is currently performing the task for this command.
An Error event may be used to indicate some type of hardware failure for the device.
A Mode Change event may be used to indicate when the specified local module (including plug-and-play modules) changes between Active and Sleep mode.
A Return Link Keys event may be used to return stored link keys after a Read_Stored_Link_Key command is used.
A PIN Code Request event may be used to indicate that a PIN code is required to create a new link key for a connection.
A Link Key Request event may be used to indicate that a Link Key is required for the connection with the device specified in the address parameter.
A Link Key Notification event may be used to indicate to the Host that a new Link Key has been created for the connection with the device specified in the address parameter.
A Data Buffer Overflow event may be used to indicate that a specified local module's data buffers have overflowed, because the Host has sent more packets than allowed.

It can be seen that a fully plug-and-play system can thus be configured in which new devices (handsets, sensing or alarm modules, etc.) can be “attached” to an existing system, for example, by simply keying in a PIN corresponding to a particular ID. Devices within a given system (and modules in a given device) can communicate with each other with automatic device discovery (in which a device determines what active devices are available within the system, and what active modules are available within the device, so that all devices know the complete and updated list of active devices/modules with which to establish a communications link) and automatic feature discovery (in which, once a destination device or module has been selected, a manual or automatic process can be performed to inform the originating device of the capabilities of the destination device). It will be appreciated, however, that the handset 12 can be configured within the scope of the present invention in a number of different ways, to have additional, omitted, and/or different functions and/or functionalities.

In one preferred embodiment of the present invention, the handset 12 is configured to communicate with various devices such as external memory, message processor, data processor, video processor, audio processor, display processor, ground positioning processor, sensor and universal remote control module for control of TV sets, VCR sets, CD players, cable boxes, and/or other apparatus such as satellite receivers and security devices. The handset 12 is preferably further configured to utilize several communication protocols employed by various manufactures or various models of the same brand. Typically, each manufacturer of one of these devices such as TV sets, VCR sets, CD players, cable boxes and satellite receivers, employs a specific communication protocol that includes a command code set for performing various functions to remotely control the device. Each command code set comprises a set of signals, each of which is utilized to perform an available function. For example, a TV set made by manufacturer A, may require a command code set that includes various signals to remotely control various available functions such as channel up, channel down, volume up, volume down, mute, and power “on” and “off.” This command code set may have a different set of signals than another command code set employed for a TV set made by manufacturer B. In the alternative, manufacturer A may employ different command code sets for its own various models of TV sets.

It will be appreciated that a handset capable of communicating with substantially all major brands of various devices, and/or transmitting IR frequencies insulated with control signals ranging from 20-130 kHz, requires a substantially large memory to store all the command code sets with various sets of signals. For example, it may be desirable to store approximately 500 different code sets that may be used by the handset 12 to remotely communicate with major brand TV sets, VCR sets, CDs and cable boxes. These devices are adapted to receive IR signals with frequencies ranging from 20-130 kHz. On the average, each command code set may contain about 20 signals, wherein each signal is used to perform a desired function. Assuming that the average length of a signal to be generated has a duration of one second, the required memory space to store all the signals for the desired command code sets may be calculated. Thus, since the average number of signals per command code set is 20, and there are about 500 command code sets, the handset 12 may be required to store data that represents approximately 10,000 IR signals at an average frequency of 100 kHz, each signal having an average duration of one second. Assuming a Nyquist sampling rate, each signal with a duration of one second may be represented by 200 Kbits or approximately 20 Kbytes of data. Thus, for 10,000 IR signals, a memory space in an order of 200 Mbyts of data is desirable. However, it may be desirable to provide the handset 12 with a smaller memory space on the order of 10 Kbytes of data, in which case it is necessary to load new codes in a separate plug-and-play memory module and/or store the desired command code sets at a highly compression ratio.

An example of a suitable encoding technique to store the desired signals in a memory space in compressed form is next explained in more detail. In order to substantially decrease the amount of memory necessary to store IR signals, a module in the handset 12 or a plug-and-play memory module can retrieve data from a memory device, such as a RAM or ROM internal to the module and/or external EPROM or EEPROM, that is configured so as to store a finite set of parameters that may be used to recreate and generate signals corresponding to a desired command code set, and which take substantially less memory space than if the entire signal were to be stored. As mentioned previously, each command code set includes a set of signals that may be employed to transmit a specific command to a RF and/or IR receiver located in an electronic device that is being controlled. (Although the following details concern the creation of control code for encoding as an IR signal, the same code can be directly used to modulate an RF carrier for subsequent transmission as an RF signal by linking the signal as shown in FIG. 4).

In one embodiment, each command code set can be represented by parameters stored in an array comprising a set of variable fields that may vary in size depending on the amount of information stored in each field. These arrays are categorized as parent or root arrays and child or branch arrays. A parent array contains parameters that may be utilized to generate a set of IR signals that belong to a desired command code set. A child array relates to its parent array, and is used to generate a different set of signals that belong to a different desired command code set. A child array may store those parameters that are different from its parent array, but may not store those parameters that are substantially similar to those of its parent array. For such parameters, the child array retrieves the necessary information from the corresponding field in its parent array to generate the signals that belong to a command code set corresponding to this child array. This arrangement leads to a substantial reduction in memory space required to store parameters corresponding to various command code sets. Specifically, the savings in memory space increases with the number of child arrays corresponding to a parent array.

Parent and child arrays may also refer to certain parameters in other arrays to generate some of the signals that are desired in conjunction with generating a command code set, and a system may also be configured such that a set of signals belonging to a command code set may be generated by using parameters stored in one array, and remaining sets of signals belonging to the same command code set may be generated by using parameters stored in other arrays.

The above-described encoding technique is next explained in more detail; however, it is noted that the invention is not limited in scope in this respect. As mentioned previously, in a preferred embodiment, the specific fields of each array can have a variable length to substantially minimize the use of memory space.

### Default 2 Keys Number Field (3 Bits)

The first field in a parent or child array is identified as “default 2 keys number.” The information contained in this field represents the number of keys that when pressed, the handset 12 generates a signal that does not belong to a command code set that is being currently generated. The purpose for this field is that in certain circumstances, while the handset 12 is generating signals corresponding to a command code set to remotely control a device, it is also desired to generate signals that correspond to a command code set for remotely controlling another device, so that at least two devices are remotely controlled concurrently. For example, sometimes when the handset 12 is configured to generate signals for controlling a TV set, it is desirable that the handset 12 also generate signals for controlling some of the functions of a VCR set, even though the handset is configured to generate a TV command code set. For this particular example, the number of keys that generate VCR related signals, while the handset 12 is also generating TV set related signals, is stored in default 2 keys number field.

### Default 2 Keys Field (Variable Length)

The next field in the array is identified as “default 2 keys.” This field has a variable length depending on the “default 2 keys number” specified by a command code set. The information contained in this field identifies the keys on the handset 12, that if pressed would generate a signal created by referring to an array other than the one currently being retrieved from. In accordance with one embodiment of the present invention, each key is represented by six bits. The three most significant bits indicate the row and the three least significant bits indicate the column of a key on the handset 12. Thus the length of the “default 2 keys” field is substantially equal to “default 2 keys number” multiplied by 6 bits. It will be appreciated that the length of “default 2 keys” field is zero when “default 2 keys number” has a zero value.

### Default 2 Operation Mode Field (2 Bits)

The next field in the array is identified as default 2 operation mode. In one embodiment of a handset 12 in accordance with the invention, this field may be present only when default 2 keys number has a value other than zero. In that event, the information in this field may be a 2 bits data word, representing the mode of operation for those keys on the handset that control a different device other than the one being controlled by the remaining keys. These modes of operation may be the types of devices that default 2 keys may control, such as digital satellite mode, TV mode, VCR mode, CD mode or CABLE mode.

### Default 2 Code Field (8 Bits)

The next field in the array is identified as default 2 code. The information in this field identifies the array that contains the command code set information to be used for generating signals associated with default 2 keys. The length of this field is 8 bits, and, therefore, up to 255 different command code sets for each possible value of the default 2 operation mode field may be retrieved for generating the desired signals corresponding to the default 2 keys. When default 2 code is 255, the handset 12 generates signals corresponding to the array currently being processed in the specific default 2 operation mode. In that event, the system does not refer to any other array.

### Default Operation Mode Field (2 Bits)

The next field in the array identifies the default operation mode. This information represents the mode of operation for the keys on the handset that control a specific device. These modes of operation may be the types of devices that the handset 12 may control, such as TV mode, VCR mode, CD mode or CABLE mode. The mode information indicates the type of command code set that may be generated for a selected array.

### Default Code Field (8 Bits)

The next field in the array identifies the default command code set that relates to the present command code set that is being generated based on the information contained in the array. Typically, if the array being selected corresponds to a child array, the information in the default code field identifies the parent array from which additional information may be retrieved to generate the signals corresponding to this child array. As will be explained in more detail with reference to specific fields contained in a parent array, the information necessary to create the signals for a child command code set are stored in a parent array corresponding to the child array. This information may include the clocking and pulse characteristics of the signals that are common among a parent and all of its children arrays.

In certain circumstances, not all of the information between a child array and its parent are common. Thus, if information in a specific field in the child array is not found, the default command code set is located, which identifies the parent array corresponding to the child array, and information from the parent array is retrieved. If, however, the module finds the information in the selected child array, it creates the necessary signals based on the information located in the child array, without reverting back to the parent array identified in the default code field.

When the default code is 255, the module is notified that the present array corresponds to a parent command code set and all the information necessary to generate the square waves that form a signal may be retrieved from the present array. There are eight fields that together provide the information necessary to construct the square waves that may be employed to form the signals corresponding to a command code set. These eight fields are preferably stored in an array corresponding to a parent command code set.

Typically, at least one criterion for selecting a parent array and its corresponding children array is to analyze the shape of logical “1”s and “0”s that are generated pursuant to various command code sets for remotely controlling various devices. For a group of command code sets that have similar signal wave characteristics, information corresponding to such characteristics is stored preferably only in a parent array. The remaining children arrays that require the same logical “1”s and “0”s having the same shape as those of the parent command code set, do not have the necessary information in their appropriate fields. All the command code sets that require the same information in these eight fields are thus referred to as a family of command code sets comprising a parent array and a plurality of children arrays. For all command code sets within the same family, the module refers to the parent command code set to generate the logical “1”s and “0”s. In one embodiment of the invention, each logical “1” and “0” is formed by a set of pulses having a specific sequence of bits. The eight fields that correspond to the shape of logical “1”s and “0”s are next explained in more detail.

### Clock 0 Width (5 Bits) and Clock 1 Width (5 Bits) Fields

The information in these fields indicates the frequency of the IR signals that may be generated in conjunction with the present command code set. Each of these two variables may vary from 0 to 31. A value of 31 instructs the module to generate a square wave with the longest period available, and, a value of 0 instructs the module to generate a square wave with the smallest period available. The module, based on the information in these fields, may generate square waves with a period between 9.5 microseconds and 41.5 microseconds, in increments of 0.5 microseconds. It will be appreciated that the present invention is not limited in scope in this respect and square waves with other periods may be generated.

### Pulse 1 Width Field (1 Byte)

The information in this field represents the length of a pulse containing a plurality of square waves mentioned above. The value in this field may vary from 0 to 255, allowing for 255 periods per each pulse. For example, for IR signals having a frequency of 40 kHz, the generated square waves have a period of approximately 25 microseconds. If it is desired that each pulse contain 255 square waves, the total length of each pulse adds up to 6.3 ms.

### Length of Shape of 1 Field (5 Bits)

In one embodiment of the present invention, each signal associated with a command code set comprises a plurality of logical “1”s and “0”s. A logical “1” may include a plurality of pulses as explained above. The length of shape of 1 field contains the information regarding the number of pulses that form a logical 1. In this particular embodiment, a logical 1 may be represented by a sequence of 32 pulses.

### Shape of 1 Field

This field contains a sequence of bits representing a logical “1.” For example, for certain type of devices, a logical “1” is represented by a sequence of “1001101.” In this example, the length of shape of 1 field is 7. Every time that the handset 12 generates a logical “1” for this device, a sequence “1001101” is generated, where each “1” is a pulse having a width represented in pulse 1 width field. This pulse, in turn, modulates a carrier frequency represented by clock 0 and clock 1 fields.

### Length of Shape of 0 Field (5 Bits) and Shape of 0 Field

The information contained in these fields represent a logical “0” employed by a desired command code set, and are similar in form to logical “1” explained above.

### Length of Dependent Sequence Field (5 Bits)

A dependent sequence is a set of logical “1”s and “0”s that are desired to be transmitted in response to a key pressed on the handset 12. It will be appreciated that for each remotely controlled device, a different dependent sequence is transmitted in response to a specific key. The handset 12 also generates a different dependent sequence for each key pressed depending on the type or model of the remotely controlled device.

The information contained in the length of dependent sequence field indicates the length of the dependent sequence that is generated in response to a key pressed. In general, all keys corresponding to the same command code set have dependent sequences with the same length. Those keys corresponding to the same command code set that do not have a dependent sequence with the same length may be treated separately. For example, a separate array may be formed for those command code sets the dependent sequence lengths of which are not the same for all keys pressed.

The fields in an array described up to this point represent generally the information relating to the keys of the handset 12, and the way square wave signals and logical “1”s and “0”s may be created. The remaining fields contain “message” information, which represents how each signal in a command code may be generated in response to a key pressed on the handset 12.

### Constant Square Wave Code Field (3 Bits)

Certain devices that are desired to be remotely controlled by the handset 12 require reception of a constant square wave prior to receiving a signal associated with a command code set employed to control these devices. The constant square wave code field indicates whether prior to or after generation of a signal, or within a signal, it is necessary to transmit a constant square wave to notify the receiving device that a signal will be transmitted. If the array contains a predetermined code, such as “001” in this field, the module will generate a constant square wave.

### Length of Constant Square Wave Field (12 Bits)

This field represents the length of a constant square wave that is to be transmitted prior to or after the transmission of a signal, or within a signal, generated in response to a key pressed on handset 12. In one embodiment of the invention, the value in this field may vary between 0 and 4095. A zero value indicates that a constant signal is not to be generated. A 4095 value indicates that a constant signal is to be generated until the associated key is no longer pressed. A 4094 value indicates that for a 40 kHz IR signal, a constant square wave of approximately 100 ms is to be generated.

### Constant High Level Code (3 Bits)

Certain devices that are desired to be remotely controlled by the handset 12 require reception of a delay between two consecutive portions of information transmitted thereby. The constant high level code field indicates whether it is necessary to provide a delay in accordance with a desired command code set whose signals are being generated by the module. If the array contains a predetermined code, such as “011” in this field, the module will generate a constant high level code delay.

### Length of Constant High Level Code (12 Bits)

This field represents the length of a delay necessary between two sets of information transmitted by the handset 12. For example, for certain command code sets, a signal is desired to be repeatedly transmitted to a receiving device. The information in the constant high level code determines the delay between the signals. For certain other command code sets, it may be desired to provide a delay between two portions of information in a signal that is being transmitted. Again, the information in the constant high level code indicates the length of delay between the transmissions. A zero value indicates that a delay is not to be generated.

### Repetition Code Field (3 Bits)

In certain circumstances when a key on the handset 12 is pressed, the handset 12 transmits the same signal repeatedly. For example, when the handset 12 is functioning in TV mode, remotely controlling a TV set, when volume up or volume down keys are pressed, the signal representing these commands is repeatedly sent to the TV set until the key is no longer pressed. The repetition code field is provided to indicate to the module when such repetition is desired. Thus, the repetition code field may contain a predetermined code such as “011,” that when present indicates that the remaining fields in the message must be repeated until the key being pressed is no longer pressed.

### Simple Sequence Code Field (3 Bits)

In certain circumstances when a key on the handset 12 is pressed, the handset 12 transmits a preamble formed of a predetermined sequence of bits to prompt the remotely controlled device to receive the actual signal representing a function that can be remotely controlled. The simple sequence code field is provided to indicate to the module when such sequence is desired. Thus, the simple sequence code field may contain a predetermined code such as “100,” that when present indicates that a sequence of bits must be transmitted when a key on the handset 12 is pressed. Preferably, the simple sequence code does not depend on the key pressed, and, the same simple sequence is generated in response to any of the keys pressed.

### Simple Sequence Negation Field (1 Bit)

As previously mentioned, certain remotely controlled devices may receive a message repeatedly when the repetition code field is set with a predetermined code such as “011.” There are also certain devices that are adapted to receive a negated version of a sequence every time the handset 12 sends the sequence. For example, if in a series of repeated transmissions, a sequence “11100011” is the first transmitted, the next time that this sequence is transmitted, the handset 12 transmits “00011100,” which is the negated version of the prior sequence. The simple sequence negation code field is provided to indicate to the module when such negation is desired.

### Length of Simple Sequence Field (5 Bits)

This field indicates the length of the simple sequence that must be transmitted by the handset 12 in response to a key pressed.

### Simple Sequence Field

This field contains the actual sequence of binary bits adapted to be transmitted to a remotely controlled device in response to a key pressed on the handset 12. It will be appreciated that the shape of “1”s and “0”s transmitted to the remotely controlled device may preferably follow the patterns defined in the prior fields, explained above, with respect to characteristics and the shape of pulses representing a logical “1” or a “0.” When it is desired to transmit a preamble simple sequence code, the module generates the appropriate sequence regardless of the key pressed on the handset 12. Thus, a preamble sequence code is transmitted in response to any one of the keys pressed on the handset, prior to the transmission of signals, after the signals, or within the signals, that represent the actual command/or function that is desired to remotely control.

In certain circumstances it is also desired, in addition to the simple sequence code, to generate a set of signals that are transmitted depending on the key pressed on the handset 12. These key-dependent signals are explained in more detail hereinafter.

### Dependent Sequence Code Right (3 Bits), Dependent Sequence Code Left (3 Bits)

For many remotely controlled devices, a series of related keys pressed on the handset 12 may generate sequences that are closely related to each other. For example, when a number key such as zero is pressed, a dependent sequence “0000” may be generated. When a key such as “1” is pressed, a dependent sequence “0001” is pressed and so forth. In one embodiment of the present invention, instead of storing the dependent sequence for all the numbers, it is desirable to store only one or two dependent sequences corresponding to numbers “0” and “1” respectively. When a number other than “0” or “1” is pressed on the handset 12, a dependent sequence is generated by adding an appropriate amount of “1”s to the dependent sequence representing “0” or “1.” It will be appreciated that a considerable amount of memory may be saved by employing this technique. It will also be appreciated that the architecture in accordance with this invention provides an easy adaptive means to enable other codes by use of input/output connectivity.

The dependent sequence code right or left fields indicate whether “1”s must be added to the right side of the dependent sequence that has been actually stored or to its left side. A predetermined code such as “101” indicates that the addition is made to the right side. A predetermined code such as “110” indicates that the addition is made to the left side.

### Dependent Sequence Negation Field (1 Bit)

The effect of this field is similar to the simple sequence negation code field previously explained. Thus, when it is desired to transmit a set of dependent sequences repeatedly, there are certain devices that expect to receive a negated version of the previously received dependent sequence. When this field is set to indicate negation, each transmission of a dependent sequence in a series of repetitions contains the negated version of bits previously transmitted.

### Addition Code Field (3 Bits)

The information contained in this field indicates whether a specific type of key has an associated set of dependent sequence bits stored in memory, or whether such dependent sequence may be calculated by employing an appropriate addition function to another dependent sequence of bits stored in memory. For example, the first bit in the code may indicate that dependent sequences corresponding to number keys may be calculated by performing an addition to a dependent sequence representing a “0” number key or a “1” number key. Thus when this bit is set to “1,” the module adds an appropriate amount to an already stored dependent sequence and transmits the resultant dependent sequence in response to a number key pressed.

The second bit in the addition code field may indicate that dependent sequences corresponding to volume up and volume down keys may be calculated by performing an addition to a dependent sequence representing a specific volume level. Thus when this bit is set to “1,” the module adds an appropriate amount to an already stored dependent sequence representing a specific volume level, and transmits the resultant dependent sequence in response to a volume key pressed.

The third bit in the addition code field may indicate that dependent sequences corresponding to channel up and channel down keys may be calculated in a manner substantially similar to that explained in conjunction with volume up and volume down keys.

### Existing Keys Field (38 Bits)

This field contains 38 bits of information, where each “set” bit represents a key that is stored in the present command code set. For example, the existing keys for remotely controlling a VCR set may include, play key, fast forward key, rewind key, mute key, volume up key, channel up key, recall key, channel down key, number “0” and number “1” keys, enter key, pause key, stop key, record key, power key and so forth. When it is desired that the handset 12 generate a signal in response to any one of these keys, the corresponding bit in the existing keys field is set to 1 if that specific key is stored in the current command code set. The information in this field is thus retrieved, and it is determined whether a dependent sequence should be generated in response to a key pressed on the handset 12.

When the addition code for a predetermined type of keys is set to 1, only the dependent sequence corresponding to one of the keys is stored, and the dependent sequences corresponding to the remaining related keys may be calculated by performing an appropriate addition. The number of bits set in the existing keys field equals the length of dependent sequence generated field divided by the length of dependent sequences field.

It will be appreciated that the present invention is not limited in scope in this respect and there may be more or less than 38 bits representing 38 keys in response to which a dependent sequence is generated.

### Dependent Sequence Generated Field

The information contained in this field represents the actual dependent sequence for each of the keys represented as “1” in the existing keys field. Thus, after the module determines that a dependent sequence must be generated in response to a key pressed on the handset 12, it refers to the dependent sequence generated field to determine the actual sequence that must be transmitted in response to the key pressed. The length of this field is variable and depends on the length of the dependent sequence generated in response to a pressed key and the number of keys in response to which a dependent sequence is generated. As mentioned previously, the length of the dependent sequence is stored in the field identified as the length of dependent sequence field.

### Sequence Repetition Code Field (3 Bits)

In certain circumstances, it is desired to transmit a simple sequence or a dependent sequence several times within the same message that is being transmitted in response to a key pressed. Instead of storing the sequence many times within the message, it is desirable to store a code in the sequence repetition code field, such as “111,” indicating that the handset 12 must generate a simple sequence or a dependent sequence again.

### Sequence Repetition Index Field (2 Bits)

This field indicates which one of the simple or dependent sequences previously generated must be generated again. An index “00” indicates that a first set of simple sequences are desired to be generated again. Likewise, an index “01” indicates that a second set of simple sequences previously generated are desired to be generated again. An index “11” indicates that a dependent sequence previously generated needs to be generated again. An index “10” indicates that sequence repetition must be canceled. For example, assume that a parent array includes a sequence repetition code indicating that a sequence must be generated again. If, in the child array, the index in sequence repetition index field is set to “10,” the module will not generate a sequence again when the command code set corresponding to a child array is being executed.

It will be appreciated that a sequence of signals for a desired command code set may be generated based on the information contained in a corresponding parent or child array, and a system may be configured capable of generating signals for a variety of command code sets used by commercially available devices. In order to construct these parent and child arrays, first all signals generated by various remote controllers that control most of the commercially available devices may be analyzed. In accordance with one method for constructing parent and child arrays, a signal analyzer is coupled to the output of different commercially available remote controllers to determine the command code set corresponding to each controller formed by a sequence of signals generated in response to keys pressed on those controllers. These signals are then analyzed either manually or by utilizing a computer program, in order to categorize the command code sets into parent and child command code sets.

In light of the foregoing description, some particular adaptations or applications of the present invention will be noted. For example, one embodiment of a system in accordance with the present invention provides an integrated universal remote control with one-way and/or two-way communication with external plug-and-play devices (connected to the plug-and-play modules 41 and 45) in a plurality of RF and/or IR links over input/ouput ports 47 and 49. In such an embodiment, a plug-and-play video module can be connected to the handset 12 to capture and process visual images, and the handset 12 can record the images (and preferably also sound) on a plug-and-play memory module, and/or process/display the images on a plug-and-play display module, and/or link the images with the master application/interface controller 22 for transmission to a base station 13, and/or link the images to other wired external end equipment. Concurrently, the base station 13 can communicate the images and sound to a wired and/or wireless source over input/ouput port 49, and the images and sound can be sent over a public or private, wireless or wired network (such as the internet), for remote real-time access by for example a computer or a security or monitoring agency, and can receive back commands and/or software updates from these remote locations. In such an embodiment, the handset 12 could also utilize a plug-and-play ground position system (GPS) module to locate where an image is being taken, and thus tag the image with coordinates for use by a security or monitoring agency in real-time or post real-time. A plug-and-play onboard or remote sensor(s) could also be activated, and relevant data captured and transmitted as a telemetry stream to a remote source.

In another embodiment of the present invention, the base station 13 could be used to provide a communication platform to link a portable medical device to a doctor's office or a portable monitoring device to a security agency, and could provide voice communications to a wired and/or wireless source. In such an embodiment, the handset 12 could employ a plug-and-play GPS module to provide the location where the medical and/or environmental situation is located, and could also, for example, concurrently link to a security agency's external monitoring sensors measuring certain environmental parameters of interest to said agencies.

In another embodiment of the present invention, a plug-and-play data module could be provided to capture all (or only specified) remote control data transactions and time-tag them, archive them in a database, manipulate the database, format certain relational data elements in one or more file formats, and manually or automatically transmit related files over wired and/or wireless communication links. In this embodiment, time-tagging TV, digital satellite system receiver, and cable box channel changes, or other time tagged events that cause the viewer or listener to observe a different display or listen to a different sound source, can be provided.

It will be appreciated from the foregoing description that a system in accordance with the present invention can be configured and/or adapted to meet individual user needs from simple residential functionality to highly sophisticated and complex operability found in commercial, industrial and government agencies. The ability to communicate directly with other devices via RF and/or IR signals and/or wired connection, which includes telephone lines/cables with added plug-and-play utility, to perform communications, command, and control functions can provide a number of utility, portability, availability, and cost advantages, and can be employed to address limitations of multiple and incompatible means in telephony, information processing, internet, sensing, and other applications. The option to select frequency transmission or reception in either a RF or IR frequency or plug-and-play connection can be used to address environmental operating problems and current response time limitations, because the option to transmit in IR or by wired plug-and-play connection can be beneficial in environments where RF transmission is detrimental to other operating devices, while the option to transmit in RF capability can be beneficial where obstructed line of sight and lack of reflecting surfaces hinders IR transmission. The availability of a backup signal link between RF transmission or reception and IR transmission or reception can insure link connection should a particular component fail in either the RF or IR circuits. Further, the option of using programmable external memory and generalized signal processing based on the open system interconnection architecture and plug-and-play adaptability can be used to provide a flexible means of communicating with accessory appliances or apparatus without the need for additional, incompatible, hand-held remote control or other wired and/or wireless communications devices. And the present invention can be employed with plug-and-play application microprocessors and/or external modules, such as memory chips, loaded with new databases, which can be added similarly as in current personal computer application add-ons, upgrades and/or expansions, except that it can be accomplished via an ac power line, other plug-to-plug connections, a telephone line, a telephone handset and/or. base unit transceiver, a personal or laptop computer, or another apparatus that operates in RF or IR, and/or USB or similar wired connection.

Although the present invention has been described in the context of particular preferred embodiments, one skilled in the art will appreciate that numerous variations, modifications, and other applications are also within the scope of the present invention. Thus, the foregoing detailed description of preferred embodiments is not intended in any way to limit the invention, which is limited only by the following claims and their legal equivalents.

1. A communication, command, and control unit for use in a modular and adaptive communication, command, and control system, said communication, command, and control unit having an external housing and including:
a. an interface module including a command and control input means;
b. an input/output module including an input/output port;
c. a plug-and-play connector; and,
d. a master application/interface controller module connected to said interface module, said input/output module, and said plug-and-play connector.

2. The communication, command, and control unit of claim 1, wherein said master application/interface controller can be dynamically programmed with one or more generic application interfaces.

3. The communication, command, and control unit of claim 1, wherein said master application/interface controller can be dynamically programmed with one or more module-specific application interfaces.

4. The communication, command, and control unit of claim 1, wherein said master application/interface controller can be dynamically programmed with a set of generic application interfaces and a set of module-specific application interfaces, and wherein said set of generic application interfaces and module-specific application interfaces are configured to permit said communication, command, and control unit to interface with and control multiple home electronic devices.

5. The communication, command, and control unit of claim 1, wherein said input/output module includes at least one element selected from the following set: an RF transceiver, and an IR transceiver.

6. The communication, command, and control unit of claim 1, wherein said input/output module includes an RF transceiver and an IR transceiver.

7. The communication, command and control unit of claim 1, wherein said input/output module includes at least one element selected from the following set: a USB adapter, a RJ 11 jack, an AC power line plug, an optic cable adapter, a RF cable adapter, and a point-to-point wire connector.

8. The communication, command, and control unit of claim 1, wherein said command and control input means includes at least one element selected from the following set: a keypad, a touch screen, and a microphone.

9. The communication, command, and control unit of claim 1, wherein said interface module further includes a display means.

10. The communication, command, and control unit of claim 1, wherein said input/output port includes a wired input/output port connected to said master application/interface controller module.

11. The communication, command, and control unit of claim 10, wherein said communication, command, and control unit is a base station.

12. The communication, command, and control unit of claim 1, wherein said communication, command, and control unit is a handset.

13. The communication, command, and control unit of claim 12, wherein said handset is adapted to connect with a base station so as to form an integrated handset/base station pair.

14. The communication, command, and control unit of claim 1, further comprising a plug-and-play module connected to said plug-and-play connector.

15. The communication, command, and control unit of claim 1, wherein said communication, command, and control unit is adapted for use in one or more information handling/processing/networking, industrial, commercial, medical, military, or security-related applications.

16. The communication, command, and control unit of claim 15, further comprising a plug-and-play module adapted to perform one or more information handling/processing/networking, industrial, commercial, medical, military, or security functions and connected to said plug-and-play connector.

17. A communication, command, and control unit for use with an information handling/processing/networking, industrial, commercial, medical, military, or security system, said communication, command, and control unit having an external housing and including:
a. an interface module including a command and control input means;
b. an input/output module including an input/output port;
c. a plug-and-play connector; and,
d. a master application/interface controller module connected to said interface module, said input/output module, and said plug-and-play connector.

18. The communication, command, and control unit of claim 17, further comprising a plug-and-play module adapted to perform security functions and connected to said plug-and-play connector.

19. A modular communication, command, and control system comprising at least one handset and at least one base station, wherein each of said handset and said base station includes:
a. a housing;
b. an interface module including a command and control input means;
c. an input/output module including an input/output port;
d. a plug-and-play connector; and,
e. a master application/interface controller module connected to said interface module, said input/output module, and said plug-and-play connector.

20. The modular communication, command, and control system of claim 19, wherein said handset and said base station are adapted to connect with each other so as to form an integrated handset/base station pair.
